(19) United States
(12) Patent Application Publication
(10) Pub. No.: US 2022/0033135 A1
(43) Pub. Date: Feb. 3, 2022

(54) TAMPER-EVIDENT BOX FOR EDIBLE CONTENTS

(71) Applicant: Mollen Kaigongi KAIRIA, Vacaville, CA (US)

(72) Inventor: Mollen Kaigongi KAIRIA, Vacaville, CA (US)

(21) Appl. No.: 17/390,554

(22) Filed: Jul. 30, 2021

Related U.S. Application Data
(63) Continuation-in-part of application No. 17/358,396, filed on Jun. 25, 2021.
(60) Provisional application No. 63/059,334, filed on Jul. 31, 2020.

(51) Int. Cl. B65D 5/54; B65D 5/66; B65D 5/42; B65D 81/38; B65D 85/36; A47J 47/14

(52) U.S. Cl. CPC B65D 5/546; B65D 5/6626; B65D 5/4295; B65D 81/3858; B65D 2585/366; A47J 47/145; B65D 2205/02; B65D 2401/25; B65D 85/36

(57) ABSTRACT

The tamper-evident box for edible content generally includes a box having a base portion, sidewall portions, and a lid portion defining an interior volume. A front tab portion of the lid includes an adhesive tamper-evident seal that secures the lid to the front sidewall to maintain the box in a closed configuration. The box further includes multiple vents at the sidewall corners to reduce moisture buildup, and the interior of the box includes a layer of insulating material configured to maintain the contents of the box at a desired temperature. The box further includes a breakaway cutter tab disposed on a lower front corner which is used to cut across the adhesive seal and access the contents of the box. The lid and sidewalls include tabs that allow the box to secured closed position even after the seal is broken.

### CROSS-REFERENCE TO RELATED APPLICATIONS

The present invention claims priority to U.S. provisional application Ser. No. 63/059,334, filed Jul. 31, 2020, entitled “VIP Choice Pizza Box” and is a continuation in part application to U.S. Nonprovisional application Ser. No. 17/358,396, filed Jun. 25, 2021 entitled “Tamperproof Bag”, which are hereby incorporated in their entirety at least by reference.

### BACKGROUND OF THE INVENTION

### 1. Field of the Invention

The present invention generally relates to a food container, more particularly, the present invention relates to a tamper-evident box for edible contents.

### 2. Description of Related Art

Pizza and similar types of foods are often packaged and delivered in a box that includes a base with four sidewalls and a hinged lid that closes overtop. While these containers perform the function of storing the pizza prior to consumption, they have several drawbacks. For example, these containers are often made from solid cardboard material which can cause the contents to overheat and become waterlogged due to steam being released. Another common issue is that the containers having weak tabs holding the lid closed. The lid often opens accidentally, spilling the contents of the container and ruining them. These containers also lack any sealing mechanism that would notify the intended recipient that the box has been tampered with prior to receipt. Customers have no way of knowing if someone accesses the contents of the container between the container leaving the restaurant and arriving at the customer. Consequently, a tamper-evident box is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a tamper-evident pizza box that prevents third parties from accessing the contents prior to the pizza box arriving to the customer. It is an additional object of the invention, to provide a pizza box which prevents heat loss of the contents during transportation.

In order to do so, a tamper-evident pizza box is provided, comprising a rectangular box having a base portion, sidewall portions, and a lid portion defining a main interior volume, wherein the interior volume is sized to hold a pizza; the rectangular box comprised of an inner layer, a middle layer, and an outer layer, the middle layer positioned between the inner layer and the outer layer, wherein the middle layer is constructed from an insulation material; a first planer member adjacent to and extending from a front portion of the lid portion and a second planer member adjacent to and extending from the first planer member; a pull tab attached to a breakaway perforated tear-open section extending along the entirety of the first planer member; and, a tamper-evident adhesive seal positioned on the second planer member.

In one embodiment, the insulation material is aluminum foil. In one embodiment, the breakaway perforated tear-open section enables a remaining tab portion of the first planer member to tuck into a front sidewall of the sidewall portions such that the tamper-evident pizza box may be reclosed after the breakaway perforated tear-open section is opened. In one embodiment, the inner layer and the outer layer is constructed from cardboard. In one embodiment, wherein the first planer member is rotatably joined to the front portion. In another embodiment, the second planer member is rotatably joined to the first planner member. In one embodiment, the first and second planer members have a width equal to a width of the lid front portion of the lid portion. In one embodiment, the tamper-evident adhesive seal is configured to seal to the base portion, such that the first planner member is aligned with a front sidewall of the sidewall portions. In yet another embodiment, the tamper-evident adhesive seal is disposed underneath a removable peel-off cover. In one embodiment, the pull tab extends outwardly from a perimeter edge of the first planner member. In one embodiment, the rectangular box includes at least one vent to prevent overheating of the pizza and reduce moisture buildup within the interior volume. In another embodiment, wherein the at least one vent is a pair of curved vents positioned at a first rear corner and a second rear corner of the lid portion. In one embodiment, the rectangular box is square. In one embodiment, the sidewall portions have a height approximately 1½ to 2 inches.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of the tamper-evident box for edible contents with the lid portion in an open position according to an embodiment of the present invention;

FIG. 2 is a perspective view of the tamper-evident box with the lid portion in a closed position according to an embodiment of the present invention;

FIG. 3 is a perspective view of the tamper-evident box with the lid portion in the open position showing the insulation layer according to an embodiment of the present invention;

FIG. 4 is a perspective view of the tamper-evident box with the lid portion in the closed position showing the insulation layer according to an embodiment of the present invention;

FIG. 5 is a perspective view of an alternative tamper-evident box for edible contents with the lid portion in an open position according to an embodiment of the present invention;

FIG. 6 is a perspective view of the alternative tamper-evident box with the lid portion in the open position showing the insulation layer according to an embodiment of the present invention; and,

FIG. 7 is a top view of the alternative tamper-evident box in a flattened position prior to assembly according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a tamper-evident box for edible contents.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words “a” or “an”, or other words using the singular or plural number also include the plural or singular number, respectively. As used in this application, the term “about” or “approximately” refers to a range of values within plus or minus 10% of the specified number. Additionally, the words “herein,” “above,” “below,” and words of similar import, when used in this application, shall refer to this application as a whole and not to any particular portions of this application.

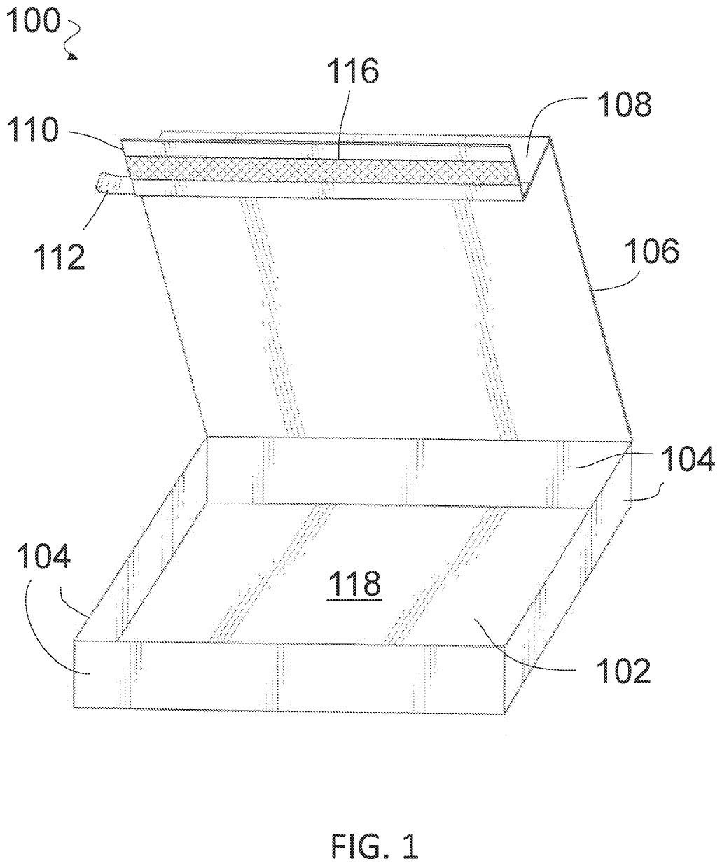

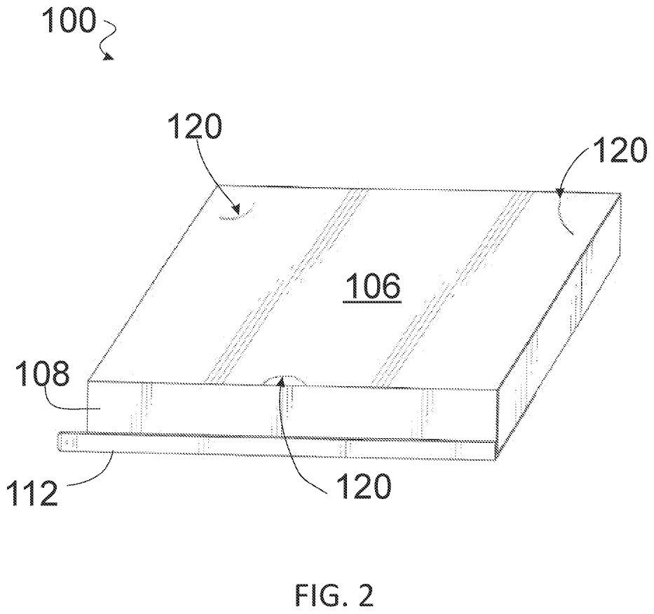

Referring now to FIGS. 1-2, various perspective views are illustrated showing the tamper-evident box for edible contents in the open and closed position respectively. In one embodiment, the tamper-evident box 100 comprises a base portion 102, sidewall portions 104, and a lid portion 106 defining an interior volume 118. The interior volume 118 configured to store the edible contents, such as a pizza. In one embodiment, the lid portion 106 includes a planar member 108 having a front tab 110 with a sealing adhesive 116 disposed underneath a removable peel-off cover. In one embodiment, the planer member is adjacent to and extends from a front portion of the lid portion. The planer member is rotatably joined to the front portion, as the planer member is a bent section of the lid portion. Similarly, the front tab 110 is a second planer member adjacent to and extending from the (first) planer member 108. Likewise, the second planer member is rotatably joined to planner member 108, as the second planer member is an additional bent section of the lid portion, wherein the lid portion is pre-bent to from the first and second planer members.

Advantageously, the adhesive provides a tamper-evident seal that secures the lid 106 to the base portion to maintain the box in a closed configuration, as shown in FIG. 2. In other embodiments, the adhesive provides a tamper-evident seal that secures the lid 106 to a front sidewall 104A of sidewall portions. In order for an individual to access the box, the seal must be broken, such that any attempt to access the box will leave visible evidence.

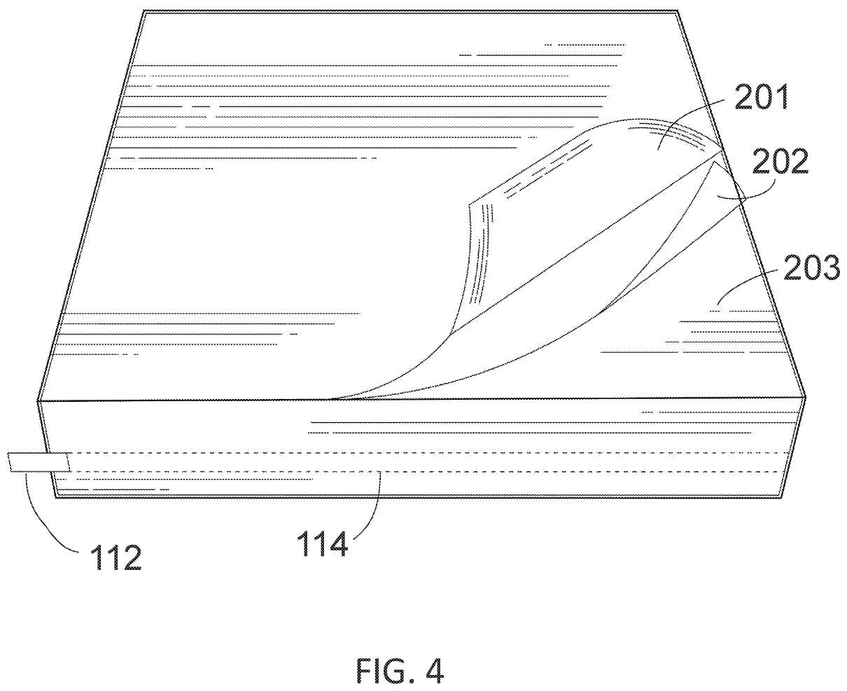

In one embodiment, the tamper-evident box 100 further includes a breakaway cutter tab 112 disposed on a lower front corner which is used to cut across the adhesive seal and access the contents of the box. The breakaway tab can include cutting teeth 114 (FIG. 4) or similar elements to aid in the removal of the tamper-evident seal and the opening of the container. In some embodiments, the breakaway tab is breakaway perforated tear-open section that is configured to separate the first planner member 108 into two portions, one portion 108A, i.e. what remains of the first planner member, acts as a tab such that the such that the tamper-evident box may be reclosed after the breakaway perforated tear-open section is opened. In some embodiments, the tab portion of the remaining section is tucked in front of the front side wall 104A, similar to the normal closure of a box as known in the art. The other remaining section is the front tab 110, also referred to as a second planer member, which remains secured to a bottom side of the base portion 102 or front side wall 104A when the tamper-evident pizza box 100 is sealed.

In some embodiments, in operation, the tab is pulled across the width of the front of the box. This drags the cutting teeth or similar elements across the adhesive tamper evident seal, which causes the seal to break and release, allowing the individual to access the contents of the container. In some embodiments, the box includes additional tabs that can act as handles for assisting with opening or closing the lid after the seal has been broken. In some embodiments, the cutting teeth defining the breakaway perforated tear-open section extends the entire width of the planer member 108.

Best seen in FIG. 2, the lid portion and/or the sidewall portion include a plurality of vents 120. Advantageously, the shape of the vents can vary to achieve proper airflow. For example, in the shown embodiment, the lid of the box includes curved vents positioned at the rear corners of the lid portion. In other embodiments, additional vents or differently sized vents can be utilized, such as on the front portion of the lid portion and the sidewalls. Further, the pull tab extends outwardly from the perimeter edge of the box so that it can be easily gripped by the user. When the pulled tab is utilized to remove the adhesive closure, the box still has closure tabs that operate to close the box again and maintain it in that position. In this way, the user can secure the lid to keep the contents protected even after the lid seal has been broken with the pull tab cutting element.

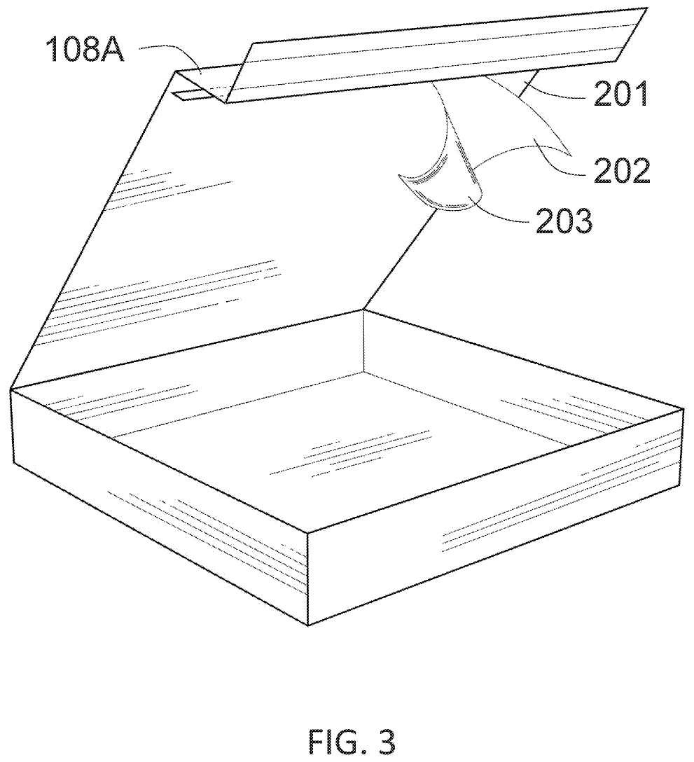

As seen in FIGS. 3-4, the interior of the box includes an insulating material 202 in order to maintain the contents of the box at an elevated temperature. In one embodiment, the insulating material includes a layer of aluminum foil that is laminated between inner 203 and outer walls 201 of the box. In combination with the improved temperature maintenance of the contents, i.e. the pizza, vents are provided as previously discussed in order to prevent overheating of the contents. For instance, the box further includes multiple vents at the sidewall corners or lid portions as previously discussed to reduce moisture buildup. Although three layers are illustrated, it should be understood that additional layers may be provided. Further, it should be understood that other insulating materials may be provided, including but not limited, to polyethylene, polypropylene, cotton, paper, foam, and other known insulation materials.

In one embodiment, the tamper-evident box is a rectangular box. In some embodiments, the rectangular box is a square box. In other embodiments, the box is circular, partially rectangular, diamond shaped, triangular, polygon, or irregular polygon shape. It is important that the height of the box is minimal to maintain the heat and temperature without wasted space. In some embodiments, especially if the box is intended for pizza, the height is approximately 1½-2 inches. The size of the box, such as the length and width of the box may vary as the size of the pizza or other edible content may vary as well known in the art. In some embodiments, the length and width may vary between approximately 6 inches to 20 inches. In some embodiments, the outer and inner walls of the tamper-evident box are constructed from cardboard or corrugated cardboard, fiberboard or similar materials.

It should be understood, that the box may be modified to contain any known edible contents, like bakery products, take-out food, etc. In these embodiments, the size of the box may vary depending on the contents.

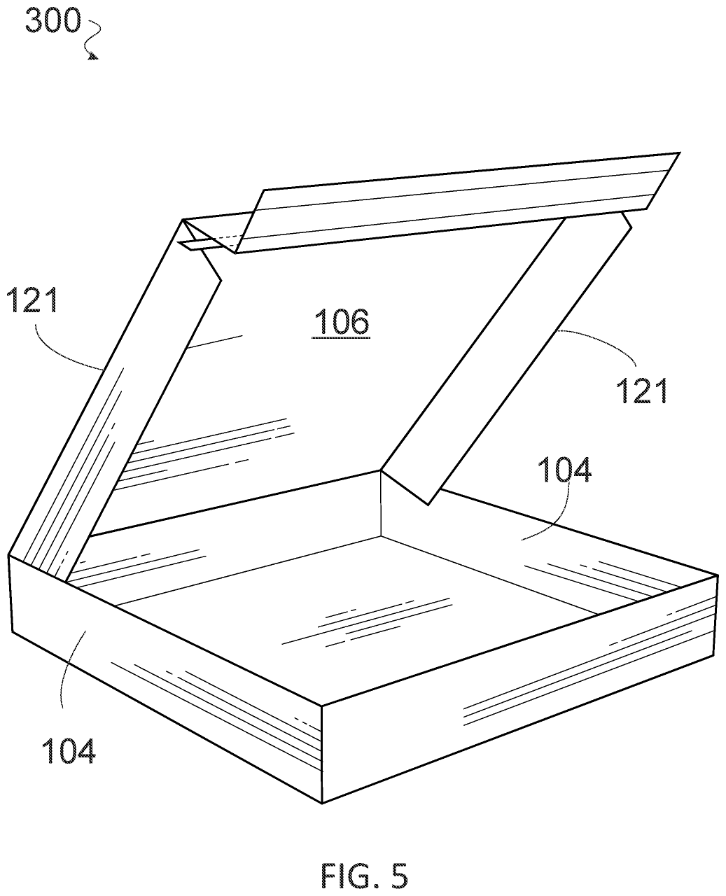

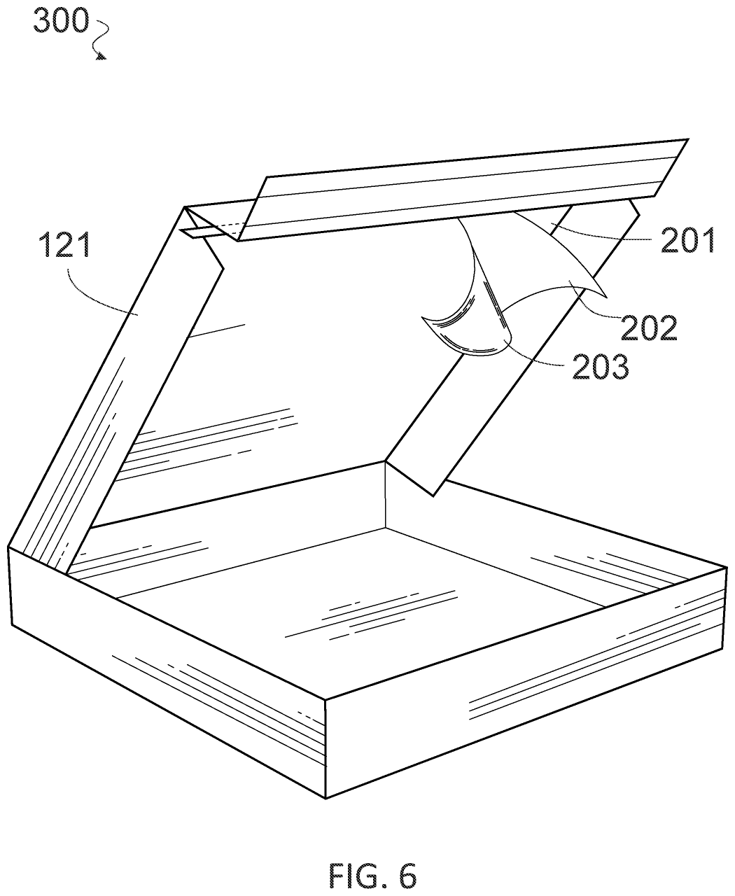

Referring now to FIGS. 5-6, perspective views are illustrated showing an alternative tamper-evident box 300 for edible contents in the open position. The alternative tamper-evident box 300 is constructed similarly as the tamper evident box 100 described above. In one embodiment, box 300 has identical structure to box 100 besides the addition of side members 121, which may also be referred to as planer side members. In one embodiment, the side members 121 are adjacent to each side of the lid portion 106, wherein the side members 121 are configured to tuck into the side wall portions 104 when closing the tamper-evident box 300.

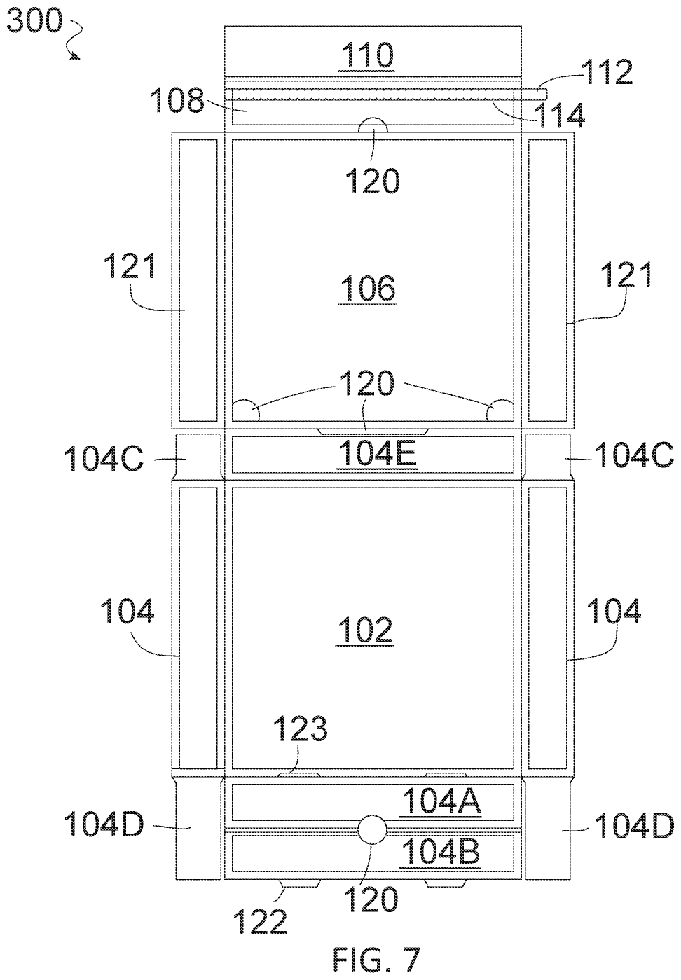

FIG. 7 is a top view of the alternative tamper-evident box 300 in a flattened position prior to assembly according to an embodiment of the present invention. In the illustrated positioned, all the structural components are visible besides the insulation layer. The alternative tamper-evident box 300 comprises a lid portion 106 with adjacent side members 121 and adjacent first (planer) member 108 having a second (planer) member 110 adjacent to and extending from the first member 108. The first member 108 having breakaway cutter tab 112 and cutting teeth 114 as previously described. The alternative tamper-evident box 300 further comprising base portion 102 with attached sidewalls 104. Sidewall portion 104E being attached to the lid portion 106 as illustrated. In one embodiment, the front sidewall portion is comprised of two sidewall members 104A and 104B which are folded together to form a more rigid front sidewall portion. Tab portions 122 and openings 123 secure the front sidewall portion to the base portion 102. Flaps 104C and 104D enable a continuous sidewall structure by enabling the connection to each adjacent sidewall portion. For example, flaps 104C enable the connection of sidewall portions 104 to 104D, whereas flaps 104D enable the connection of sidewall portions 104 to the front sidewall portion (combination of 104A and 104B). As previously mentioned, various vents 120 may be provided to provide airflow.

As well known in the art, the box is scored at the intersection of the structural members of the invention such that one structural member may be folded in relation to another member such that adjacent members are rotatable in relation to each other.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A tamper-evident pizza box comprising:
a rectangular box having a base portion, sidewall portions, and a lid portion defining a main interior volume, wherein the interior volume is sized to hold a pizza;
the rectangular box comprised of an inner layer, a middle layer, and an outer layer, the middle layer positioned between the inner layer and the outer layer, wherein the middle layer is constructed from an insulation material;
a first planer member adjacent to and extending from a front portion of the lid portion and a second planer member adjacent to and extending from the first planer member;
a pull tab attached to a breakaway perforated tear-open section extending along the entirety of the first planer member; and,
a tamper-evident adhesive seal positioned on the second planer member.

2. The tamper-evident pizza box of claim 1, wherein the insulation material is aluminum foil.

3. The tamper-evident pizza box of claim 1, wherein the breakaway perforated tear-open section enables a remaining tab portion of the first planer member to tuck into a front sidewall of the sidewall portions such that the tamper-evident pizza box may be reclosed after the breakaway perforated tear-open section is opened.

4. The tamper-evident pizza box of claim 1, wherein the inner layer and the outer layer is constructed from cardboard.

5. The tamper-evident pizza box of claim 1, wherein the first planer member is rotatably joined to the front portion.

6. The tamper-evident pizza box of claim 5, wherein the second planer member is rotatably joined to the first planner member.

7. The tamper-evident pizza box of claim 1, wherein the first and second planer members have a width equal to a width of the lid front portion of the lid portion.

8. The tamper-evident pizza box of claim 1, wherein the tamper-evident adhesive seal is configured to seal to the base portion, such that the first planner member is aligned with a front sidewall of the sidewall portions.

9. The tamper-evident pizza box of claim 1, wherein the tamper-evident adhesive seal is disposed underneath a removable peel-off cover.

10. The tamper-evident pizza box of claim 1, wherein the pull tab extends outwardly from a perimeter edge of the first planner member.

11. The tamper-evident pizza box of claim 1, wherein the rectangular box includes at least one vent to prevent overheating of the pizza and reduce moisture buildup within the interior volume.

12. The tamper-evident pizza box of claim 11, wherein the at least one vent is a pair of curved vents positioned at a first rear corner and a second rear corner of the lid portion.

13. The tamper-evident pizza box of claim 1, wherein the rectangular box is square.

14. The tamper-evident pizza box of claim 1, wherein the sidewall portions have a height approximately 1½ to 2 inches.

15. A tamper-evident box for edible contents comprising:
a box having a base portion, sidewall portions, and a lid portion defining a main interior volume, wherein the interior volume is sized to hold a pizza;
a first member adjacent to and extending from a front portion of the lid portion and a second member adjacent to and extending from the first member;
a pull tab attached to a breakaway perforated tear-open section extending along the entirety of the first member; and,
a tamper-evident adhesive seal positioned on the second member.

16. The tamper-evident box for edible contents of claim 15, wherein the box is comprised of an inner layer, a middle layer, and an outer layer, the middle layer positioned between the inner layer and the outer layer, wherein the middle layer is constructed from an insulation material.

17. The tamper-evident box for edible contents of claim 15, wherein the first member is rotatably joined to the front portion.

18. The tamper-evident box for edible contents of claim 15, wherein the second member is rotatably joined to the first member.
